(19) United States
(12) Patent Application Publication
(10) Pub. No.: US 2026/0241994 A1
(43) Pub. Date: Aug. 20, 2026

(54) STEERING ANGLE CONTROL APPARATUS AND STEERING ANGLE CONTROL METHOD

(71) Applicant: Honda Motor Co., Ltd., Tokyo (JP)

(72) Inventors: Kazuki Tomioka, Tokyo (JP); Yuta Tsurumoto, Tokyo (JP)

(21) Appl. No.: 19/536,110

(22) Filed: Feb. 10, 2026

(30) Foreign Application Priority Data
Feb. 14, 2025 (JP) 2025-022427

(51) Int. Cl. B62D 15/02

(52) U.S. Cl. CPC B62D 15/025

(57) ABSTRACT

A steering angle control apparatus is configured to control a steering angle of a vehicle such that the vehicle travels following a target route. The steering angle control apparatus performs: predicting, up to a predetermined time ahead, a behavior of the vehicle including a deviation in a position and a direction of the vehicle with respect to the target route, based on a vehicle state quantity indicating a motion state of the vehicle and information indicating the target route; and optimizing a target steering angle by using a result of the predicting. The optimizing includes performing optimization using an evaluation function including a first element intended to suppress the deviation and a second element intended to suppress a change amount of the steering angle.

### CROSS-REFERENCE TO RELATED APPLICATION

This application is based upon and claims the benefit of priority from Japanese Patent Application No. 2025-022427 filed on Feb. 14, 2025, the content of which is incorporated herein by reference.

### BACKGROUND

### Technical Field

The present invention relates to a steering angle control apparatus and a steering angle control method for controlling a steering angle of a vehicle based on a vehicle model modeling a motion state of a vehicle.

### Related Art

There is known a technique for controlling a steering actuator of a subject vehicle so that the subject vehicle travels according to a target path (see JP 2019-167039 A).

In the technique described in JP 2019-167039 A, at least one of a braking/driving actuator or the steering actuator is controlled such that the subject vehicle travels according to the target path identified by a driving path identification unit. Although it is disclosed that the subject vehicle is caused to travel along the target path, correction of the steering when the position of the subject vehicle deviates from the target path is not disclosed. Therefore, there is room for improvement in following the target route.

Performing follow driving along the target route leads to suppression of a decrease in traffic smoothness while improving traffic safety. Accordingly, it is possible to contribute to development of a sustainable transportation system.

### SUMMARY

An aspect of the present invention is a steering angle control apparatus configured to control a steering angle of a vehicle such that the vehicle travels following a target route. The steering angle control apparatus includes: a microprocessor; and a memory connected to the microprocessor. The microprocessor is configured to perform: predicting, up to a predetermined time ahead, a behavior of the vehicle including a deviation in a position and a direction of the vehicle with respect to the target route, based on a vehicle state quantity indicating a motion state of the vehicle and information indicating the target route; and optimizing a target steering angle by using a result of the predicting. The microprocessor is configured to perform the optimizing including performing optimization using an evaluation function including a first element intended to suppress the deviation and a second element intended to suppress a change amount of the steering angle.

Another aspect of the present invention is a steering angle control method for controlling a steering angle of a vehicle such that the vehicle travels following a target route. The steering angle control method includes: predicting, up to a predetermined time ahead, a behavior of the vehicle including a deviation in a position and a direction of the vehicle with respect to the target route, based on a vehicle state quantity indicating a motion state of the vehicle and information indicating the target route; and optimizing a target steering angle by using a result of the predicting. The optimizing includes performing optimization using an evaluation function including a first element intended to suppress the deviation and a second element intended to suppress a change amount of the steering angle.

### BRIEF DESCRIPTION OF THE DRΔψINGS

The objects, features, and advantages of the present invention will become clearer from the following description of embodiments in relation to the attached drawings, in which:

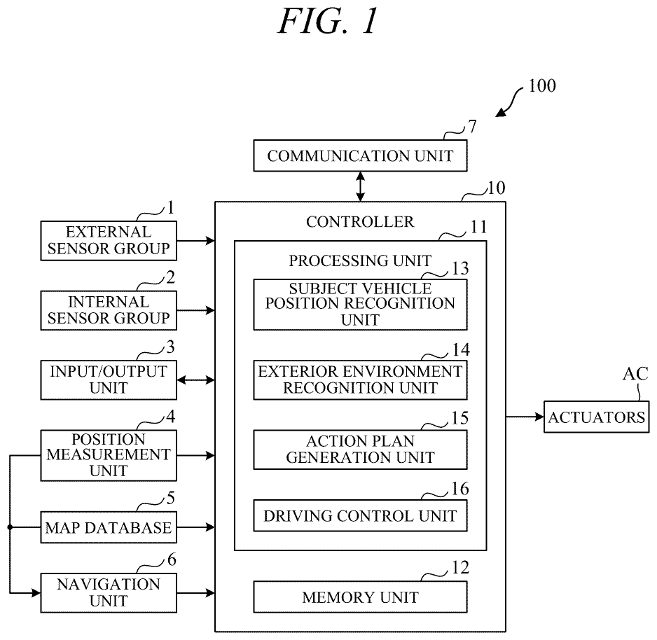

FIG. 1 is a block diagram illustrating a configuration of a vehicle control system including a steering angle control apparatus according to an embodiment of the present invention;

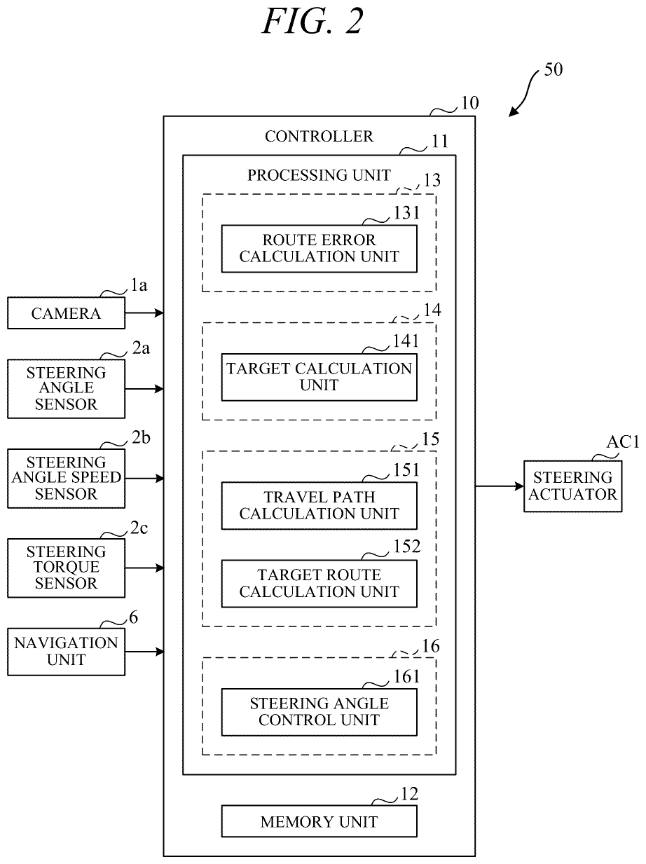

FIG. 2 is a block diagram illustrating a main configuration of a steering angle control apparatus;

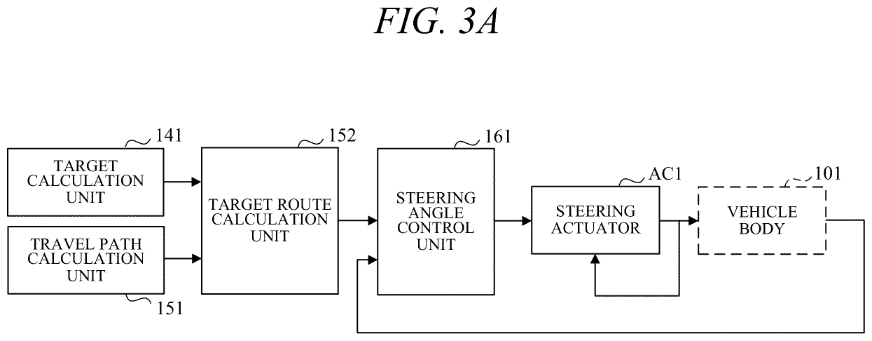

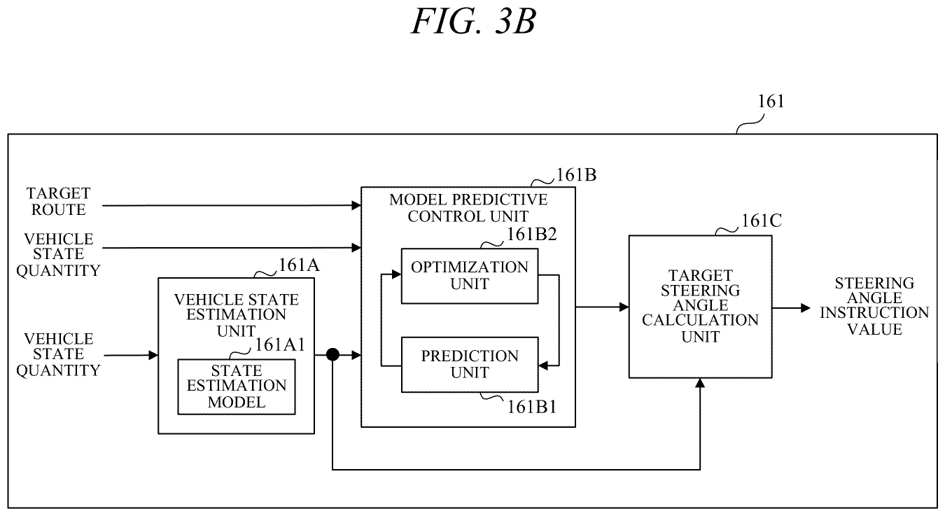

FIG. 3A is a block diagram for explaining a flow of steering angle control;

FIG. 3B is a block diagram illustrating details of the steering angle control unit in FIG. 3A;

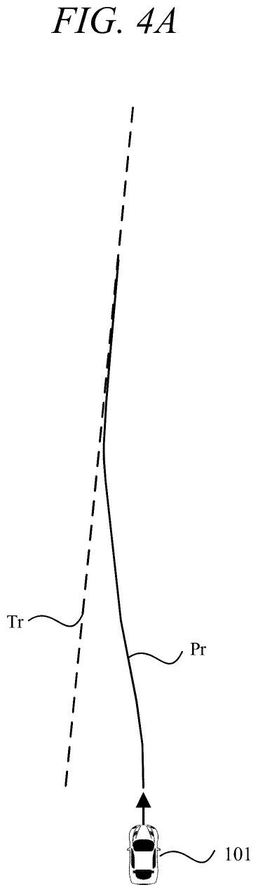

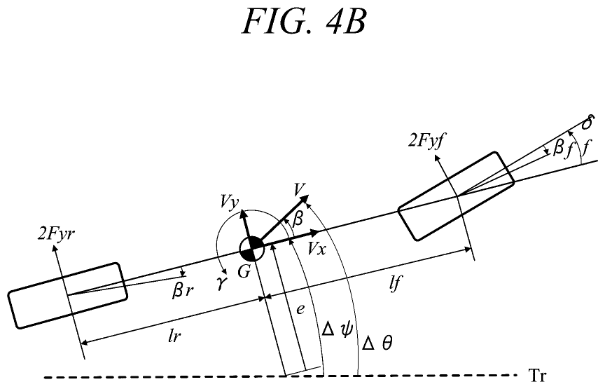

FIG. 4A is a schematic diagram illustrating an example of a predicted route that follows a target route;

FIG. 4B is a schematic diagram illustrating a relationship between a two-wheel model and the target route according to the embodiment;

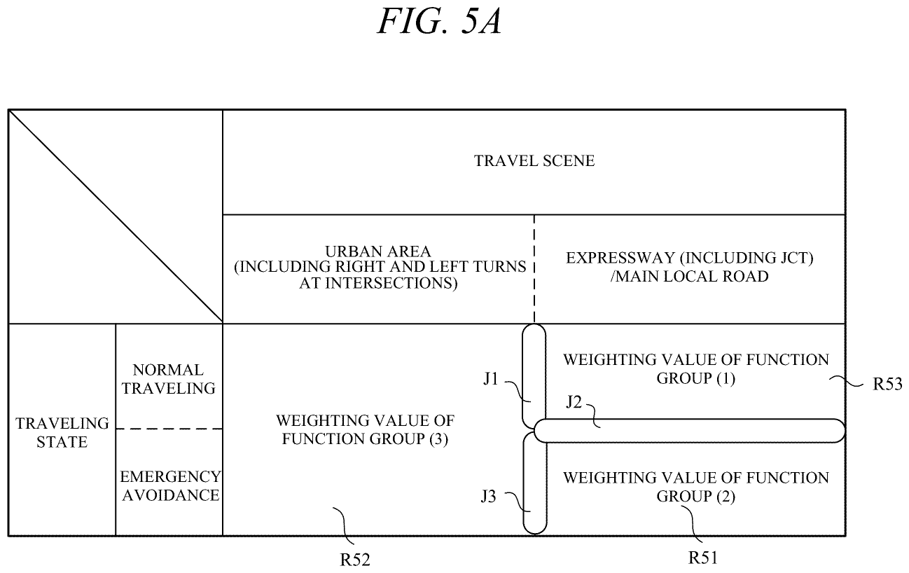

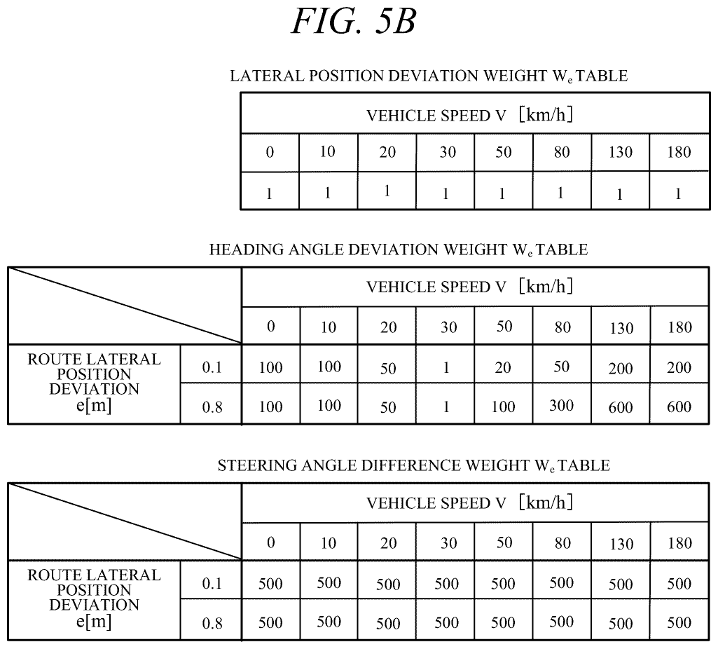

FIG. 5A is a diagram explaining categories of changes in weighting values;

FIG. 5B is a diagram explaining a combination of the weighting values;

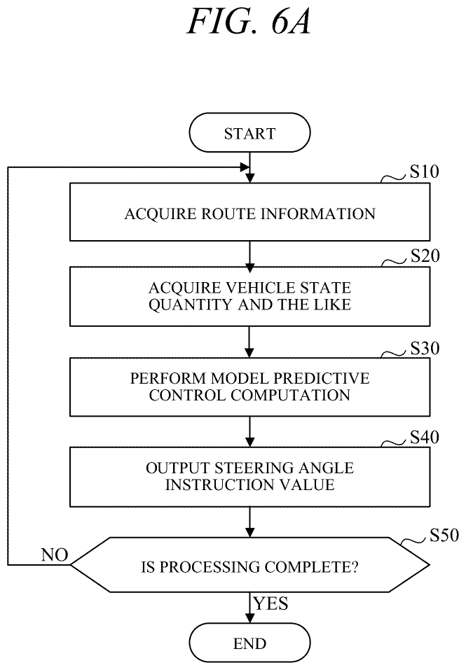

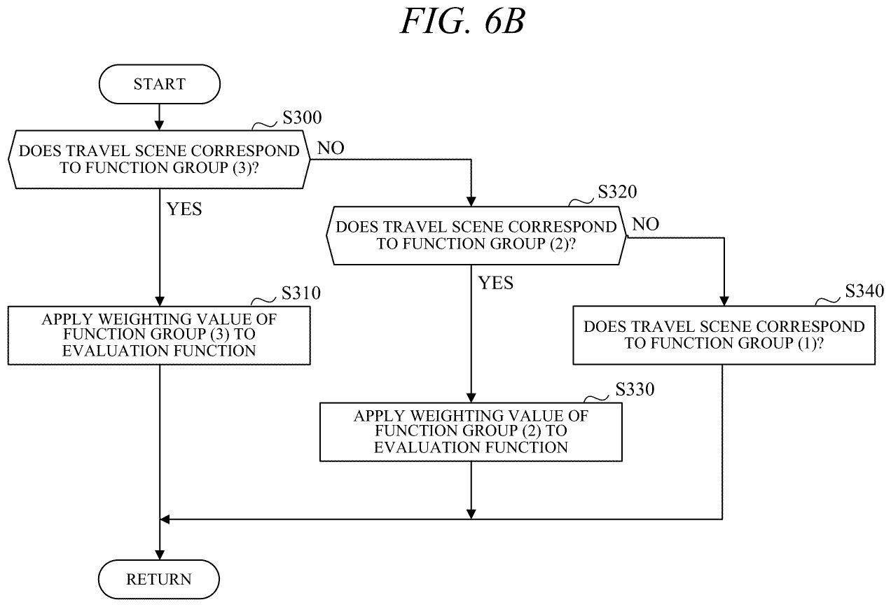

FIG. 6A is a flowchart illustrating an example of computation processing executed by the processing unit in FIG. 2 according to a program; and

FIG. 6B is a flowchart illustrating an example of computation processing executed by the processing unit in FIG. 2 according to a program.

### DETAILED DESCRIPTION

Hereinafter, embodiments of the invention will be described below with reference to the drawings.

A steering angle control apparatus according to an embodiment of the present invention controls a steering angle of a steering apparatus (for example, a power steering apparatus) of a vehicle as a control target, such that the vehicle follows a target route (which may also be referred to as a target path). The steering angle control apparatus can be applied to, for example, a vehicle having a self-driving capability, that is, a self-driving vehicle.

Note that the steering angle control apparatus according to the embodiment can be applied to both a manual driving vehicle having a driving assistance capability and a self-driving vehicle, but for the sake of convenience of description, a case where the steering angle control apparatus is applied to a self-driving vehicle will be described below as an example.

Furthermore, in the embodiment, a vehicle on which the steering angle control apparatus is mounted may be referred to as a subject vehicle to be distinguished from other vehicles. The subject vehicle may be any of an engine vehicle having an internal combustion engine (engine) as a traveling drive source, an electric vehicle having a traveling motor as a traveling drive source, and a hybrid vehicle having an engine and a traveling motor as a traveling drive source. The subject vehicle is capable of traveling not only in a self-drive mode that does not require a driver's driving operation but also traveling in a manual drive mode that requires a driver's driving operation.

### <Vehicle Configuration>

First, a schematic configuration of the subject vehicle related to self-driving will be described. FIG. 1 is a block diagram illustrating a configuration of a vehicle control system 100 of a subject vehicle including the steering angle control apparatus according to the embodiment. As illustrated in FIG. 1, the vehicle control system 100 mainly includes a controller 10, an external sensor group 1, an internal sensor group 2, an input/output device 3, a position measurement unit 4, a map database 5, a navigation unit 6, a communication unit 7, and a traveling actuator AC, each of which is communicably connected with the controller 10.

The “external sensor group 1” is a generic term for a plurality of sensors (external sensors) that detect an external situation that is surrounding information of the subject vehicle. For example, the external sensor group 1 includes a LiDAR that measures scattered light with respect to irradiation light in all directions of the subject vehicle and measures a distance from the subject vehicle to surrounding obstacles, a radar that detects other vehicles, obstacles, and the like around the subject vehicle by irradiating electromagnetic waves and detecting reflected waves, and a camera or the like that is installed in the subject vehicle, has an imaging element (image sensor) such as a charge coupled device (CCD) or a complementary metal oxide semiconductor (CMOS) sensor, and captures images of the surrounding (front, rear, and side) of the subject vehicle.

The “internal sensor group 2” is a generic term for a plurality of sensors (internal sensors) that detect a traveling state of the subject vehicle. For example, the internal sensor group 2 includes a vehicle speed sensor that detects a vehicle speed of the subject vehicle, an acceleration sensor that detects an acceleration in a front-rear direction (advancing direction) of the subject vehicle and an acceleration (lateral acceleration) in a left-right direction (lane width direction) of the subject vehicle, a revolution sensor that detects the number of revolutions of the traveling drive source, and a yaw rate sensor or the like that detects a rotation angle speed around a vertical axis of the center of gravity of the subject vehicle. The internal sensor group 2 also includes sensors that detect a driver's driving operation such as an operation on an accelerator pedal, an operation on a brake pedal, or an operation on a steering wheel in the manual drive mode.

The “input/output device 3” is a generic term for devices to and from which a command is input by a driver or information is output to the driver. For example, the input/output device 3 includes various switches to which a driver inputs various commands by operating an operation member, a microphone to which the driver inputs commands with voice, a display that provides information to the driver via a display image, a speaker that provides information to the driver with voice, and the like.

The position measurement unit (global navigation satellite system (GNSS) unit) 4 includes a positioning sensor that receives a signal for positioning, transmitted from a positioning satellite. The positioning satellite is an artificial satellite such as a global positioning system (GPS) satellite or a quasi-zenith satellite. The position measurement unit 4 uses positioning information received by the positioning sensor to measure a current position (latitude, longitude, and altitude) of the subject vehicle.

The map database 5 is a device that stores general map information to be used by the navigation unit 6, and includes, for example, a magnetic disk or a semiconductor element. The map information includes road position information, information regarding a road shape (a curvature or the like), and position information regarding intersections and branch points. Note that the map information stored in the map database 5 is different from high-precision map information stored in a memory unit 12 of the controller 10.

For example, the navigation unit 6 is a device that searches for a route on roads to a destination that has been input by a driver and that performs travel guidance along the route. The input of the destination and the travel guidance along the searched route are made via the input/output device 3. The route search is performed based on the current position of the subject vehicle measured by the position measurement unit 4, the input destination position, and the map information stored in the map database 5. It is possible to measure the current position of the subject vehicle using detection values of the external sensor group 1, and the route may be searched for, based on the current position and the high-precision map information stored in the memory unit 12.

The communication unit 7 communicates with various servers not illustrated via a network including wireless communication networks represented by the Internet, a mobile telephone network, and the like, and acquires the map information, travel history information, traffic information, and the like from the servers periodically or at an arbitrary timing. The travel history information of the subject vehicle may be transmitted to the server via the communication unit 7 in addition to the acquisition of the travel history information. The network includes not only a public wireless communication network but also a closed communication network provided for every predetermined management area, for example, a wireless LAN, Wi-Fi (registered trademark), Bluetooth (registered trademark), and the like. The acquired map information is output to the map database 5 and the memory unit 12, and the map information is updated.

The actuator AC is a traveling actuator for controlling traveling of the subject vehicle. In a case where the traveling drive source is an engine, the actuator AC includes a throttle actuator that adjusts an opening degree (a throttle opening degree) of a throttle valve of the engine. In a case where the traveling drive source is a traveling motor, the traveling motor is included in the actuator AC. The actuator AC also includes a braking actuator that actuates a braking device of the subject vehicle and a steering actuator that actuates a steering apparatus.

The controller 10 includes an electronic control unit (ECU). More specifically, the controller 10 is configured to include a computer including a processing unit 11 such as a CPU (microprocessor), the memory unit 12 such as a ROM and a RAM, and other peripheral circuits, not illustrated, such as an I/O interface.

Note that a plurality of ECUs having different functions such as an engine control ECU, a traveling motor control ECU, and a braking device ECU can be separately provided, but in FIG. 1, the controller 10 is illustrated as an aggregation of these ECUs as a matter of convenience.

The memory unit 12 stores detailed high-precision map information for self-driving. The high-precision map information includes position information of a road, information on a road shape (such as a curvature), information on gradient of a road, position information of intersections and junctions, types and position information of division lines such as white lines, information on number of lanes (driving lanes), lane width and position information of each lane (information on center position of lanes and boundaries of lane positions), position information of landmarks (such as traffic lights, signs, and buildings) serving as marks on the map, and information on road surface profiles such as road surface irregularities. The high-precision map information stored in the memory unit 12 may include high-precision map information acquired from the outside of the subject vehicle via the communication unit 7, or may include high-precision map information created by the subject vehicle itself using detection values of an external sensor group 1 or detection values of the external sensor group 1 and an internal sensor group 2. The memory unit 12 may store programs for various types of control and information such as threshold values used in the programs.

The processing unit 11 includes a subject vehicle position recognition unit 13, an exterior environment recognition unit 14, an action plan generation unit 15, and a driving control unit 16 as functional configurations.

The subject vehicle position recognition unit 13 recognizes a position of the subject vehicle (subject vehicle position) on the map, based on the position information for the subject vehicle that has been obtained by the position measurement unit 4 and the map information in the map database 5. The subject vehicle position may be recognized using the high-precision map information stored in the memory unit 12 and surrounding information of the subject vehicle that has been detected by the external sensor group 1, and thus it becomes possible to recognize the subject vehicle position with high accuracy. The movement information (a moving direction and a moving distance) of the subject vehicle may be calculated based on the detection values of the internal sensor group 2, and the position of the subject vehicle can also be recognized.

Note that when the subject vehicle position can be measured by a sensor installed on a road or outside a road side, the subject vehicle position can also be recognized by communicating with the sensor via the communication unit 7.

The exterior environment recognition unit 14 recognizes an external situation around the subject vehicle, based on a signal from the external sensor group 1 such as a camera, a LiDAR, and a radar. For example, a position, a speed, and an acceleration of a surrounding vehicle (a forward vehicle or a rearward vehicle) traveling near the subject vehicle, a position of a nearby vehicle stopped or parked around the subject vehicle, and positions and states of other objects are recognized, and target information is created.

The other objects include a sign, a traffic light, a road, a building, a guardrail, a utility pole, a signboard, a pedestrian, a bicycle, and the like. Indications such as division lines (such as a white line) and stop lines on a road surface are also included in the other objects (roads). The states of other objects include a color (red, green, yellow) of a traffic light, and the moving speed and orientation of a pedestrian or a bicycle. Some of stationary objects among the other objects constitute a landmark serving as an index of the position on the map, and the exterior environment recognition unit 14 also recognizes the position and type of the landmark.

The action plan generation unit 15 generates a driving path (target path) of the subject vehicle from a current time point to a predetermined time ahead, for example, based on a route searched by the navigation unit 6, the high-precision map information stored in the memory unit 12, the subject vehicle position recognized by the subject vehicle position recognition unit 13, and the external situation recognized by the exterior environment recognition unit 14. When a plurality of paths can be present as candidates of the target path on the route searched by the navigation unit 6, the action plan generation unit 15 selects, from among the plurality of paths, an optimal path that satisfies criteria such as compliance with laws and regulations and efficient and safe driving, and generates the selected path as the target route.

Then, the action plan generation unit 15 generates an action plan corresponding to the generated target route. The action plan generation unit 15 generates various action plans corresponding to drive modes, such as overtaking driving for overtaking a preceding vehicle, lane change driving for changing driving lanes, follow driving for following a preceding vehicle, lane keep driving for keeping the lane not to deviate from the driving lane, deceleration driving, or acceleration driving. In generating the target route, the action plan generation unit 15 first determines a drive mode, and then generates the target route, based on the drive mode.

In the self-drive mode, the driving control unit 16 controls each actuator AC such that the subject vehicle drives along the target route generated by the action plan generation unit 15. For example, the driving control unit 16 calculates a requested drive force for obtaining target acceleration for each unit time calculated by the action plan generation unit 15 in consideration of a driving resistance determined according to a road gradient or the like in the self-drive mode. For example, the actuator AC is feedback-controlled such that an actual acceleration detected by the internal sensor group 2 becomes the target acceleration. That is, the driving actuator AC is controlled such that the subject vehicle drives at the target vehicle speed and the target acceleration.

In addition, the driving control unit 16 calculates an optimal steering angle for causing the subject vehicle to follow the target route, based on a vehicle state quantity and the like observed by the internal sensor group 2 and the like in the self-drive mode. Then, a steering angle instruction signal corresponding to the calculated steering angle is output to control the steering actuator AC.

Note that in the manual drive mode, the driving control unit 16 controls each actuator AC in accordance with a drive command (such as a steering operation) from the driver acquired by the internal sensor group 2.

In the lane keep driving, by the way, the steering actuator (hereinafter, also referred to as a steering actuator) is controlled so that the subject vehicle travels while passing through a target position in a lane width direction. However, when a disturbance such as a change in slope of the road surface (a change in gradient in the lane width direction) or a strong crosswind occurs, there is a possibility that the position of the subject vehicle in the lane width direction deviates from the target position, or the orientation of the subject vehicle deviates from the advancing direction.

Therefore, in the embodiment, the following steering angle control apparatus is configured to eliminate the positional deviation of the subject vehicle occurring during traveling and the orientation deviation of the subject vehicle occurring during traveling.

### <Steering Angle Control Apparatus>

FIG. 2 is a block diagram illustrating a main configuration of a steering angle control apparatus 50 according to the embodiment. As an example, the steering angle control apparatus 50 is configured as a part of the function of the controller 10 in FIG. 1. A camera 1a, a steering angle sensor 2a, a steering angle speed sensor 2b, a steering torque sensor 2c, a navigation unit 6, and a steering actuator AC1 are connected to the controller 10.

The camera 1a is a monocular camera having an imaging element, and constitutes a part of the external sensor group 1 in FIG. 1. The camera 1a may be a stereo camera. The camera 1a is mounted at a predetermined position, for example, in a front part of the subject vehicle, and continuously images a space on a forward side of the subject vehicle to acquire an image (camera image) of a target object. The target object includes a division line or the like that defines a lane on a road. Note that the target object may be detected by a radar, a LiDAR, or the like instead of the camera 1a or together with the camera 1a.

The steering angle sensor 2a detects, for example, a rotation angle (steering angle) of a steering shaft coupled to a steering wheel (not illustrated). The steering angle speed sensor 2b detects a rotation angle speed (also referred to as a steering angle speed) of the steering shaft. The steering torque sensor 2c detects a steering operation by the driver, more specifically, steering torque that acts on the steering wheel. For example, the steering angle detected by the steering angle sensor 2a when the steering wheel is rotated leftward (counterclockwise) from the neutral position is set to a positive value, and the steering angle detected by the steering angle sensor 2a when the steering wheel is rotated rightward (clockwise) from the neutral position is set to a negative value.

The steering angle sensor 2a, the steering angle speed sensor 2b, and the steering torque sensor 2c constitute a part of the internal sensor group 2 of FIG. 1. Note that an Inertial Measurement Unit (IMU) that detects translational motion and rotational motion in three axial directions of the subject vehicle may be provided as one of the internal sensor group 2.

The controller 10 includes a route error calculation unit 131, a target calculation unit 141, a travel path calculation unit 151, a target route calculation unit 152, and a steering angle control unit 161 as functional configurations which the processing unit 11 (FIG. 1) is responsible for. Furthermore, as described above, the controller 10 includes the memory unit 12.

Note that the route error calculation unit 131 may constitute a part of the subject vehicle position recognition unit 13. The target calculation unit 141 may constitute a part of the exterior environment recognition unit 14. The travel path calculation unit 151 and the target route calculation unit 152 may constitute a part of the action plan generation unit 15. The steering angle control unit 161 may constitute a part of the driving control unit 16.

### <Route Error>

The route error calculation unit 131 compares the position and orientation of the subject vehicle recognized by the subject vehicle position recognition unit 13 with a target route set by the target route calculation unit 152 to be described later, and calculates a route lateral position deviation and a route heading angle deviation of the subject vehicle with respect to the target route immediately beside the subject vehicle.

The route error calculation unit 131 first recognizes the position and shape of the division line that defines the lane from the camera image of the camera 1a, and recognizes the lane on based on its recognition result. Next, the route error calculation unit 131 compares the recognized position, angle, and shape of the lane with the target route set by the target route calculation unit 152 to be described later, and calculates, as a route lateral position deviation, a deviation amount between the position of the subject vehicle and the position (lane center) on the target route immediately beside the subject vehicle. In addition, a deviation amount between the orientation of the subject vehicle and the heading angle of the target route immediately beside the subject vehicle is calculated as a route heading angle deviation.

The route error calculation unit 131 may calculate the route lateral position deviation and the route heading angle deviation by using the subject vehicle position and orientation recognized based on the high-precision map information stored in the memory unit 12 and the surrounding information of the subject vehicle detected by the external sensor group 1, or the subject vehicle position and orientation measured by the position measurement unit 4.

### <Target>

The target calculation unit 141 calculates information indicating a target existing around the subject vehicle. The target calculation unit 141 recognizes a target including a moving object such as other vehicle, a bicycle, and a pedestrian, and a stationary object (also referred to as a feature) such as a guardrail or a sign based on signals input from the external sensor group 1 such as the camera 1a, a LiDAR, and a radar, and outputs target information indicating the recognized target.

### <Base Travel Path>

The travel path calculation unit 151 calculates (searches for) a travel path (referred to as a base travel path) based on the current position of the subject vehicle measured by the position measurement unit 4, the position of the destination input from the driver, and the map information stored in the map database 5. The calculation of the base travel path is similar to the search for the route by the navigation unit 6. The travel path calculation unit 151 may acquire, as the base travel path, the route set by the navigation unit 6 from the navigation unit 6.

### <Target Route>

The target route calculation unit 152 sets, on the base travel path, a target position in the lane width direction through which the subject vehicle is to pass, based on the base travel path calculated by the travel path calculation unit 151 and the external situation recognized by the exterior environment recognition unit 14. When the subject vehicle is traveling, for example, in the lane keep driving, the target route calculation unit 152 repeatedly sets the target position along the advancing direction. As a result, a target route (a path obtained by connecting the target positions) is generated along the base travel path.

Note that when the exterior environment recognition unit 14 recognizes an obstacle such as a utility pole or a parked vehicle on a forward side in the advancing direction of the subject vehicle, the target route calculation unit 152 sets the target position using the target information output from the target calculation unit 141, so that a distance between the subject vehicle and the obstacle in the lane width direction is not shorter than a certain distance when the subject vehicle passes on a lateral side of the obstacle. In addition, when a lane change instruction is input from the driver via a direction indicator (not illustrated), the target route calculation unit 152 sets the target position so that the traveling position of the subject vehicle gradually moves to the center of the lane which is a change destination, along the advancing direction.

### <Steering Angle Control>

For example, in the case of lane keep driving, the steering angle control unit 161 controls the steering angle via the steering actuator AC1 such that the subject vehicle travels following the target route. Specifically, the steering angle control unit 161 calculates a steering angle necessary for causing the position of the subject vehicle to follow the target route.

### <Acquisition of Vehicle State Quantity>

The steering angle control unit 161 first acquires the target route generated by the target route calculation unit 152. In addition, the steering angle control unit 161 acquires a vehicle mass m [kg] of the subject vehicle, a yaw moment of inertia IZ [kgm²], a distance lf [m] between the center of gravity G and a front axle, a distance lr [m] between the center of gravity G and a rear axle, an equivalent cornering power Kf [N/rad] of one front wheel, an equivalent cornering power Kr [N/rad] of one rear wheel, a stability factor A [−], and the like from the memory unit 12 as design information regarding the subject vehicle. These may be referred to as vehicle characteristic information regarding a motion characteristic. In addition, some of them correspond to respective symbols in FIG. 4B described later.

The steering angle control unit 161 further acquires, as vehicle state quantities, a vehicle speed (vehicle body speed) V [m/s] of the subject vehicle, a yaw angle speed (yaw rate) γ[rad/s], a front-wheel steering angle δf [rad], a gravitational acceleration g [m/s²], a steering angle speed of [rad/s], a vehicle body orientation, the above route lateral position deviation e [m], a route heading angle deviation Δψ [rad] of the vehicle body, a yaw angle speed deviation Δγ [rad/s], and the like, from the output value of the sensor constituting the internal sensor group 2 or by calculation using the output value of the sensor.

The above “′” indicates time differentiation. That is, the steering angle speed of δf′ has the same meaning as dδf/dt. As an example, the vehicle body orientation is calculated based on the extending direction of the target route and the vehicle length direction (sometimes referred to as a longitudinal direction) of the subject vehicle recognized from a camera image of the camera 1a or the like. As described above, the route lateral position deviation e [m] is a deviation amount in the lane width direction of the position of the subject vehicle from the target route. The route heading angle deviation Δψ[rad] is a deviation angle of the orientation (vehicle body orientation) of the subject vehicle with respect to the target route. The yaw angle speed deviation Δγ [rad/s] denotes a deviation between the yaw angle speed γ [rad/s] detected by the yaw rate sensor included in the internal sensor group 2 and the target yaw angle speed (=vehicle speed V [m/s]×route curvature κ [rad/m]). The route curvature κ [rad/m] is a curvature of the target route ahead in the advancing direction of the subject vehicle, and is calculated by the steering angle control unit 161, for example.

Next, the steering angle control unit 161 estimates a state quantity that cannot be observed using the internal sensor group 2, by using a state estimation model (Expressions (1) and (2) described later) described later in detail. In the embodiment, a steering angle disturbance δd and a vehicle body slip angle β [rad] are estimated, and an effective front-wheel steering angle δf\hat{ }[rad], which excludes the steering angle disturbance δd, is calculated.

“\hat{ }” indicates an estimated value. A relationship among the front-wheel steering angle δf, the effective front-wheel steering angle δf\hat{ }, and the steering angle disturbance δd is expressed by an expression of δf=δf\hat{ }+δd. Here, the steering angle disturbance δd refers to a steering angle that does not influence the behavior of the subject vehicle, for example, as a counter-steering against a cant angle φ[rad]. The cant angle φ is a gradient in the lane width direction (road surface cross gradient). The counter-steering caused by crosswinds or a center-point offset of the steering apparatus may be included in the steering angle disturbance δd.

The vehicle body slip angle β [rad] is a deviation angle between the orientation of the vehicle body speed and the vehicle body orientation of the subject vehicle.

Note that the above steering angle speed δf may be a sensor value by the steering angle speed sensor 2b or may be a value calculated based on a sensor value by the steering angle sensor 2a. In addition, a longitudinal component of the vehicle speed V is Vx [m/s], a lateral component thereof is Vy [m/s], and a lateral component of the gravitational acceleration g [m/s²] is gy [m/s²].

### <Optimal Steering Angle Sequence>

Next, the steering angle control unit 161 inputs the acquired vehicle state quantities, the above m, the above lf, the above lr, the above Kf, the above Kr, the above A, and the like to a travel simulation model (hereinafter, referred to as a prediction model). In the embodiment, an optimal steering angle (optimal steering angle sequence) for causing a future traveling position of the subject vehicle to follow a target route by model predictive control is calculated using a prediction model (Expressions (7) and (8) described in detail later). Details of the prediction model and the model predictive control will be described later.

### <Steering Angle Instruction Value>

The steering angle control unit 161 extracts a steering angle to be instructed at a preview time ahead from the optimal steering angle sequence, outputs, as a steering angle instruction value, a target steering angle added with the steering angle disturbance δd excluded in advance, and controls the steering angle by the steering actuator AC1.

Note that, while the steering angle control based on the target steering angle is being executed, when the steering torque is detected by the steering torque sensor 2c, the steering angle control unit 161 may determine that the steering operation by the driver has been performed (an instruction to change the steering angle has been made) and interrupt the steering angle control.

In addition, while the steering angle control based on the target steering angle is being executed, the steering angle control unit 161 may continue the steering angle control based on the target steering angle, unless the steering torque sensor 2c detects large steering torque from which the driver's intention to release route-follow driving can be clearly understood, in other words, unless a steering operation of changing the steering angle by a predetermined value or more is performed.

### <Flow of Steering Angle Control>

FIG. 3A is a block diagram for explaining a flow of steering angle control by the steering angle control unit 161. In the configuration illustrated in FIG. 2, the target calculation unit 141, the travel path calculation unit 151, the target route calculation unit 152, the steering angle control unit 161, the steering actuator AC1, and a vehicle body of a subject vehicle 101 are illustrated.

FIG. 3B is a block diagram illustrating details of the steering angle control unit 161 in FIG. 3A. The steering angle control unit 161 includes a vehicle state estimation unit 161A using a Kalman filter, a model predictive control unit 161B, and a target steering angle calculation unit 161C. In addition, the vehicle state estimation unit 161A using the Kalman filter includes a state estimation model 161A1. Furthermore, the model predictive control unit 161B includes a prediction unit 161B1 and an optimization unit 161B2.

### <Model Predictive Control>

The model predictive control will be described with reference to FIG. 3B. The model predictive control is a prior art. The model predictive control is one of control methods for calculating an optimal control input by using predictive estimation of a control target. In the model predictive control, a prediction model and an optimizer are used. The prediction model is a model for representing the control target. In the embodiment, the prediction unit 161B1 obtained by combining the vehicle model and the route deviation model is used as the prediction model. Furthermore, the optimization unit 161B2 that evaluates the operation of the prediction unit 161B1 and calculates an optimal control input is used as the optimizer.

FIG. 4A is a diagram illustrating the position of the subject vehicle 101, a target route Tr, and a predicted route Pr. FIG. 4B is a schematic diagram illustrating a relationship between a two-wheel model and the target route Tr according to the embodiment. Symbols in the drawing correspond to the vehicle speed V (a vehicle body longitudinal speed Vx, a vehicle body lateral speed Vy) of the subject vehicle 101, the center of gravity G, the yaw angle speed γ, the route heading angle deviation Δψ of the vehicle body, the route lateral position deviation e of the vehicle body, the distance lf between the center of gravity G and the front axle, the distance lr between the center of gravity G and the rear axle, the front-wheel steering angle δf, the target route Tr, the vehicle body slip angle β, a front-wheel slip angle βf, and a rear-wheel slip angle βr. In addition, Symbol 2Fyf represents a front-wheel cornering force [N] which is the product of the above Kf [N/rad] and the above βf [rad]. Symbol 2Fyr represents a rear-wheel cornering force [N] which is a product of the above Kr [N/rad] and the above βr [rad].

In the embodiment, the motion model of the subject vehicle 101 is represented by an equivalent two-wheel model in which two front wheels and two rear wheels provided in the subject vehicle 101 are moved to the center axis of the vehicle body.

The vehicle state estimation unit 161A in FIG. 3B estimates, by the state estimation model 161A1, the steering angle disturbance δd, the vehicle body slip angle β [rad], and the like based on the vehicle state quantity.

Following Expression (1) is a state equation of the state estimation model 161A1. Following Expression (2) is an output equation (also referred to as an observation equation) of the state estimation model 161A1. Expressions (1) and (2) are an example of a continuous-time state estimation model using a steering angle speed input vehicle model (two-wheel model) as the vehicle model.

$${x}^{′} = {A}_{s} x + {B}_{s} u \qquad ( 1 )$$

$$y = {C}_{s} x \qquad ( 2 )$$

Herein, a coefficient matrix in the expression is as follows.

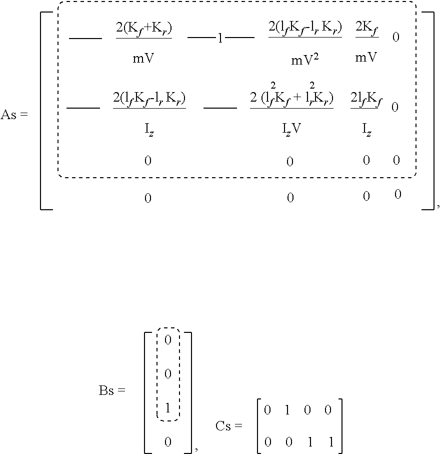

In addition, x=[β, γ, δf\hat{ }, δd]T, u=δf, and y=[γ, δf]T in the expression. Furthermore, symbols in the expression are the above Kf [N/rad], the above Kr [N/rad], the above m [kg], the above V [m/s], the above lf [m], the above lr [m], and the above IZ [kgm²]. Some of these correspond to the symbols in FIG. 4B.

Note that “[ ]T” indicates a transposed matrix. In addition, “′” indicates time differentiation. That is, x′ has the same meaning as dx/dt, and δf has the same meaning as dδf/dt. Furthermore, “\hat{ }” indicates an estimated value. That is, δf\hat{ } is an effective front-wheel steering angle estimated value of δf.

When the state equation and the output equation of above Expressions (1) and (2) are discretized, if zero-order hold assumption is applied to estimate the steering angle disturbance δd or the like, a zero-order hold discrete-time state estimation model is obtained. The zero-order hold assumption refers to, for example, a concept that the state at a previous sample time is maintained until a next sample time.

The state estimation model 161A1 models a vehicle state quantity influenced by factors such as the front-wheel steering angle speed δf [rad/s], for example, and computes estimated values of the steering angle disturbance δd, the vehicle body slip angle β and the yaw angle speed γ using these factors, observed vehicle state quantities, and previous estimated values. In addition, in general, the vehicle state quantities actually observed constantly include a noise component (observation noise), and further include a noise component (process noise) indicating model uncertainty.

By repeating the estimation computation using the state estimation model 161A1, estimation with the smallest error is performed in consideration of an observation value and the model uncertainty.

The model predictive control unit 161B inputs the target route Tr and the observed or estimated vehicle state quantity of the subject vehicle 101 and performs model predictive computation, thereby performing processing (solution search computation) of obtaining an optimal steering angle sequence for several future seconds (prediction horizon) while predicting the speed and the traveling direction (predicted route Pr) of the subject vehicle 101 for several future seconds (prediction horizon) on the model at predetermined computation intervals (for example, several milliseconds to several seconds). In the embodiment, the input x to the prediction model is information indicating the state of the subject vehicle 101 (Δθ, e), the input u is information indicating the input of the subject vehicle 101 (front-wheel steering angle δf), and the input w is information indicating the curvature κ of the target route Tr. As the steering angle δf of the input u, the above estimated value δf\hat{ } obtained by excluding the steering angle disturbance δd estimated by the vehicle state estimation unit 161A from the actual steering angle δf acquired by the internal sensor group 2 is input.

### <Description of Prediction Model>

Following Expression (3) is a state equation of the prediction model of the prediction unit 161B1. Following Expression (4) is an output equation of the prediction model of the prediction unit 161B1. Expressions (3) and (4) are an example of a continuous time prediction model based on a route deviation system including a steering angle input vehicle model (referred to as steady-state two-wheel model) representing a steady state as a vehicle model.

$${x}^{′} = {A}_{C} x + {B}_{C} u + {W}_{C} w \qquad ( 3 )$$

$$y = {C}_{C} x \qquad ( 4 )$$

Herein, a coefficient matrix in the expression is as follows.

$$Ac = [ \text{} \begin{matrix}0 & 0 \\ V & 0\end{matrix} \text{} ] , Bc = [ \text{} \begin{matrix}\frac{1}{1 + {AV}^{2}} \frac{V}{l} \\ 0\end{matrix} \text{} ] , Wc = [ \text{} \begin{matrix}- V \\ 0\end{matrix} \text{} ] , Cc = [ \text{} \begin{matrix}1 & 0 \\ 0 & 1\end{matrix} \text{} ]$$

In addition, x=[Δθ, e]T, u=δf, w=κ, and y=[Δθ, e]T in the expression. Furthermore, symbols in the expression are the above V [m/s], wheelbase 1 [m]=above lf [m]+above lr [m], the above e [m], a route heading angle deviation Δθ [rad] of a speed vector, and stability factor A [−]. In the embodiment, the route lateral position deviation e and the route heading angle deviation Δθ are treated as the route deviation system.

Note that “[ ]T” indicates a transposed matrix. In addition, “′” indicates time differentiation. That is, x′ has the same meaning as dx/dt, θ′ has the same meaning as dθ/dt, and e′ has the same meaning as de/dt.

In the embodiment, since the steering angle input vehicle model representing the steady state is used, β′ and γ′ each become 0 (zero). Therefore, the vehicle body slip angle β and the yaw angle speed γ can be treated as functions of the steering angle δf as in following Expressions (5) and (6), respectively. In addition, since Δθ=Δψ+β generally holds, the time derivative of both sides is Δθ′=Δψ′+β′. When β′=0 is substituted as the steady state, Δθ′=Δψ′ is obtained.

$$β = \frac{1}{1 + {AV}^{2}} ( 1 - \frac{m}{2 l} \frac{{l}_{f}}{{l}_{r} {K}_{r}} {V}^{2} ) \frac{{l}_{r}}{l} {δ}_{f} \qquad ( 5 )$$

$$γ = \frac{1}{1 + {AV}^{2}} \frac{V}{l} {δ}_{f} \qquad ( 6 )$$

Since the state equation (above equation (3)) of the embodiment is created by taking in the route heading angle deviation Δθ of the speed vector and its time derivative Δθ′ by applying the above, it is considerably simple as compared with the related art.

When the state equation and the output equation of above Expressions (3) and (4) are discretized, following Expressions (7) and (8) are obtained by applying first-order hold assumption. Expressions (7) and (8) are first-order hold discrete-time prediction models. The first-order hold makes it possible to maintain the accuracy of the curvature κ of the target route even when a long sample time is used, for example, as compared with the case of the zero-order hold. The first-order hold assumption refers to a concept that a state changes linearly from the state at the previous sample time to the state at the next sample time.

$$x ( k + 1 ) = {A}_{d} x ( k ) + {B}_{d 0} u ( k ) + {W}_{d 0} w ( k ) + {B}_{d 1} u ( k + 1 ) + {W}_{d 1} w ( k + 1 ) \qquad ( 7 )$$

$$y ( k ) = {C}_{d} x ( k ) \qquad ( 8 )$$

where x(k) is a state variable (in the embodiment, Δθ, e), u(k) is a vehicle input (in the embodiment, the front-wheel steering angle δf), w(k) is a disturbance component (in the embodiment, the route curvature κ), and y(k) is a vehicle output (Δθ, e).

Note that Cd=Cc, Bd0=Bd−Bd1, and Wd0=Wd−Wd1. The sizes are Ad: nx×nx, Bd0: nx×nU, Wd0: nx×nW, Bd1: nx×nU, Wd1: nx×nW, and Cd: ny×nx.

According to above Expressions (7) and (8), by repeating obtaining the vehicle state quantity at a next step k+1 based on the vehicle state quantity at step k on the model, it is possible to predict the vehicle state quantity at Hp steps ahead (k=Hp) from the current time (k=0). More specifically, the prediction unit 161B1 inputs the observed or calculated current vehicle state quantity and the like of the subject vehicle 101 to the state equation, and predicts the vehicle state quantity corresponding to each of step k=1 to step k=Hp.

The optimization unit 161B2 represents, as a function, each of a plurality of elements (in the embodiment, the route lateral position deviation e, the route heading angle deviation Δθ, and the front-wheel steering angle difference Δδf) used for evaluation and outputs the sum of the function outputs as an evaluation function J. In addition, a constraint condition to be satisfied is also set.

Following Expression (9) is an example of the evaluation function J of the optimization unit 161B2. Following Expression (10) is an example of the constraint condition.

$$min J = {\sum }_{k = 1}^{{H}_{p}} {W}_{e} {e ( k )}^{2} + {W}_{Δ θ} Δ θ {( k )}^{2} + {W}_{Δ {δ}_{f}} {\{ {δ}_{f} ( k ) - {δ}_{f} ( k - 1 ) \}}^{2} \qquad ( 9 )$$

$${\dot{δ}}_{fmin} \leq \frac{{δ}_{f} ( k ) - {δ}_{f} ( k - 1 )}{{t}_{s}} \leq {\dot{δ}}_{fmax} \qquad ( 10 )$$

where Symbol ts is a prediction sampling time, Symbol Hp is a prediction horizon, Symbol We is a weighting factor for the square of the route lateral position deviation e, Symbol WΔθ is a weighting factor for the square of the route heading angle deviation Δθ of the speed vector, and Symbol WΔδf is a weighting factor for the square of the front-wheel steering angle difference Δδf. Hereinafter, the weighting factor is referred to as a weighting value. In addition, “dot” indicates time differentiation. That is, “dot” δf has the same meaning as dδf/dt.

In the embodiment, the evaluation function J is determined by a plurality of elements. Specifically, the evaluation function J is a function f1 for the route lateral position deviation e of the vehicle body, a function f2 for the route heading angle deviation Δθ of the speed vector, and a function f3 for the front-wheel steering angle difference Δδf. The evaluation function J is a function including these three elements. The optimization unit 161B2 obtains the smallest numerical value of the evaluation function J determined by the sum of the three functions f1, f2, and B.

The three functions f1, f2, and f3 will be described in more detail. The optimization unit 161B2 calculates a multiplication result of the square of the route lateral position deviation e(k) and a weighting value We at each step from the next step k=1 to the Hp steps ahead (k=Hp) in the future, and sets the multiplication result as the function f1 for the route lateral position deviation e.

In addition, the optimization unit 161B2 calculates a multiplication result of the square of the route heading angle deviation Δθ(k) and a weighting value WΔθ at each step from the next step k=1 to the Hp steps ahead (k=Hp) in the future, and sets the multiplication result as the function f2 for the route heading angle deviation Δθ.

Furthermore, the optimization unit 161B2 calculates a multiplication result of the square of the steering angle difference (Δδf(k)−Δδf(k−1)) and a weighting value WΔδf at each step from the next step k=1 to the Hp steps ahead (k=Hp) in the future, and sets the multiplication result as the function f3 for the steering angle difference Δδf.

The model predictive control unit 161B having the above-described configuration repeats loop processing by the prediction unit 161B1 and the optimization unit 161B2 a plurality of times for each computation cycle, and determines the optimal steering angle sequence that satisfies the constraint condition and minimizes the evaluation function J. In other words, the optimal steering angle sequences u(1) to u(Hp) at each step from the next step k=1 to the Hp steps ahead (k=Hp) in the future are determined as steering angle instruction value candidates.

The target steering angle calculation unit 161C inputs the steering angle disturbance δd estimated by the vehicle state estimation unit 161A and the optimal steering angle sequences u(1) to u(Hp) determined by the model predictive control unit 161B, extracts a steering angle to be instructed at a predetermined preview time tp ahead from the optimal steering angle sequence, and outputs, as a steering angle instruction value after next several milliseconds, a target steering angle added with the steering angle disturbance δd excluded in advance to the steering actuator AC1. In the embodiment, the steering angle corresponding to the preview time tp is obtained by linear interpolation from the optimal steering angle sequences u(1) to u(Hp).

### <Change of Weighting Value>

FIG. 5A is a diagram explaining categories of changes in weighting values in the above Expression (9), which is illustrated as an evaluation function, by changing the weighting value, it is possible to set an element prioritized over other elements among a plurality of elements (in the embodiment, the route lateral position deviation e, the route heading angle deviation Δθ, and the front-wheel steering angle difference Δδf) used for evaluation.

Here, function group (1) corresponds to a driving load reduction function similar to Lane Keeping Assistance, function group (2) corresponds to an accident reduction function similar to Road Departure Mitigation, and function group (3) corresponds to the self-driving capability in urban areas.

For example, by setting the weighting value We to be larger than the other weighting values WΔθ and WΔδf, it becomes possible to perform steering angle control to converge the route lateral position deviation e as fast as possible within a range in which the subject vehicle 101 can respond (the range of the constraint condition according to above Expression (10)).

Similarly, by setting the weighting value WΔθ to be larger than the other weighting values We and WΔδf, it becomes possible to perform steering angle control to converge the route heading angle deviation Δθ as fast as possible within a range in which the subject vehicle 101 can respond (the range of the constraint condition according to above Expression (10)).

In contrast to the above two examples, by setting the weighting value WΔδf to be larger than the other weighting values We and WΔθ, it becomes possible to perform steering angle control to suppress the steering angle difference Δθf to be small (in other words, to avoid steering as much as possible). Due to the difficulty in steering, the subject vehicle 101 does not turn, resulting in steering angle control that does not follow the target route. Note that a weighting value for emergency avoidance for performing control to steer as much as possible, which is opposite to control to make it difficult to steer, can also be set. Specifically, by setting the weighting value WΔδf to zero, the subject vehicle 101 can perform steering angle control that prioritizes danger avoidance at all costs over the influence on the occupant (ride comfort or the like).

### <Change for Each Travel Scene>

In the embodiment, a scene in which the subject vehicle 101 travels is determined, and a combination of weighting values We, WΔθ, and WΔδf determined in advance for each determined scene is applied to the evaluation function of above Expression (9).

An example of changing the weighting value for each travel scene will be described with reference to FIG. 5A. In the embodiment, the traveling state of the subject vehicle 101 is classified into normal traveling and emergency avoidance. The emergency avoidance refers to a case where the exterior environment recognition unit 14 or the like determines that the subject vehicle 101 is likely to collide with an obstacle or the like if the subject vehicle travels as it is (considerably high), and an emergency avoidance flag is set. The emergency avoidance flag is reset when the exterior environment recognition unit 14 or the like determines that there is no possibility of collision with an obstacle or the like even if the subject vehicle 101 travels as it is (sufficiently low).

In the embodiment, the travel scene is further classified into two. The first scene is a case where it is determined that the travel scene corresponds to an operation design region where the self-driving capability can be provided, using the high-precision map information stored in the memory unit 12, the subject vehicle position recognized by the subject vehicle position recognition unit 13, the vehicle state quantity observed by the internal sensor group 2, and the like, which is referred to as “urban area”. The second scene is a scene of traveling on a general road or an expressway which does not correspond to the operation design region, which is referred to as an “expressway/main local road”. The expressway refers to, for example, an automobile exclusive road satisfying a predetermined standard. This includes a scene of traveling in a facility (JCT) connecting expressways.

As an example, the steering angle control unit 161 determines the travel scene as an “urban area” when it is determined that the travel scene corresponds to the operation design region where the self-driving capability can be provided, using the high-precision map information stored in the memory unit 12, the subject vehicle position recognized by the subject vehicle position recognition unit 13, the vehicle state quantity observed by the internal sensor group 2, and the like.

In addition, when it is determined that the travel scene does not correspond to the operation design region and the lane recognized by the exterior environment recognition unit 14 or the like is present, the travel scene is determined as “expressway/main local road”.

When determining the traveling state and the travel scene of the subject vehicle 101 as described above, the steering angle control unit 161 applies, to the evaluation function of above Expression (9), a combination of the weighting values We, WΔθ, and WΔδf of each function group corresponding to the determined state and scene. In FIG. 5A, in a region R53 corresponding to “expressway/main local road” normal traveling, the steering angle control unit 161 applies a combination of weighting values of the function group (1).

An example of the weighting value of the function group (1) will be described with reference to FIG. 5B. For example, the weighting values We and WΔθ determine basic path-following performance. When the absolute value of the route lateral position deviation e is less than or equal to a first predetermined length (for example, 0.1 [m]), a weighting value We and WΔθ table is determined based on the centering performance near the center of the lane. In addition, when the absolute value of the route lateral position deviation e is greater than or equal to a second predetermined length (for example, 0.8 [m]), the weighting value We and WΔθ table is determined based on the convergence performance from a state of being largely offset from the target route.

Note that when the absolute value of the route lateral position deviation e is greater than or equal to the first predetermined length and less than or equal to the second predetermined length, the weighting values We and WΔθ are linearly interpolated. In addition, the weighting value WΔδf is determined so as to reduce corrective steering within a range that does not impair the path-following performance of the function group (1).

By switching the weighting value according to the route lateral position deviation e in this manner, steering angle control is achieved which can achieve both the centering performance and the convergence performance. In other words, by giving priority to the weighting value We near the center of the lane and giving priority to the weighting value WΔθ in the state of being largely offset from the target route, the steering angle control is achieved which can achieve both the centering performance and the convergence performance.

The steering angle control unit 161 applies a combination of the weighting values of the function group (2) in a region R51 corresponding to “expressway/main local road” emergency avoidance. Although not illustrated, a weighting value table of the function group (2) is provided separately from the weighting value table of the function group (1) illustrated in FIG. 5B. For example, the steering angle control unit 161 applies, to the evaluation function of above Expression (9), a combination (for example, We=1, WΔθ=1, and WΔδf=0 regardless of the route lateral position deviation e) of the weighting values We, WΔθ, and WΔδf determined in advance for emergency avoidance. The steering angle control unit 161 may further execute a separately set emergency avoidance control system. By setting the weighting value WΔθ as small as possible and setting the weighting value WΔδf to 0, the steering angle control is performed to converge the route lateral position deviation e at the fastest speed necessary for emergency avoidance. That is, during emergency, in order to avoid collision or the like at all costs, the steering angle control is performed to avoid danger by performing rapid steering.

The steering angle control unit 161 applies the combination of the weighting values of the function group (3) in a region R52 corresponding to “urban area”. Although not illustrated, a weighting value table of the function group (3) is provided separately from the weighting value tables of the function group (1) and the function group (2). For example, when the vehicle speed V is less than or equal to a predetermined value (for example, 100 [km/h]), the weighting values WΔθ and WΔδf are made smaller than those of the function group (1), whereby the steering angle control prioritizes the centering performance as compared with the function group (1).

In FIG. 5A, in the region R52 corresponding to “urban area”, the steering angle control unit 161 applies a combination of weighting values of the function group (3) regardless of whether the traveling state is “normal traveling” or “emergency avoidance”. The reason why the combination of the weighting values We, WΔθ, and WΔδf for emergency avoidance is not used in the region R52 is as follows. That is, since the self-driving capability of the function group (3) frequently interferes with an accident reduction function of the conventional function group (2), the function group (3) is planned including an accident reduction function similar to the road departure mitigation. Accordingly, the function group (3) does not depend on the conventional traveling state.

For example, in a scene of overtaking a parked vehicle on a road shoulder, the vehicle may temporarily cross a center line. Conventionally, the state transitions from “normal traveling” to “emergency avoidance” in this scene, but the function group (3) understands the scene and sets the target route Tr for avoiding the parked vehicle, and thus does not depend on the conventional traveling state.

### <Change of Joint Region>

In joint regions J1 to J3 located at boundaries among the region R51 to the region R53 described above, the steering angle control unit 161 may apply, to the evaluation function of above Expression (9), a combination of weighting values We, WΔθ, and WΔθf determined in advance for the joint regions J1 to J3.

The joint regions J1 to J3 correspond to a case where the steering angle control unit 161 determines a travel scene or a traveling state different from the previous travel scene or traveling state. In the joint regions J1 to J3, the combination of the weighting values is applied to the evaluation function of above Expression (9) so as to gradually change the combination of the weighting values We, WΔθ, and WΔθf, in other words, so as to give a fade effect. A period for applying the fade effect is, for example, longer than the computation cycle of the processing by the prediction unit 161B1 and the optimization unit 161B2. This makes it possible to avoid a sudden change in the steering angle control at a timing when regions 51 to 53 in FIG. 5A change, in other words, make it difficult for an occupant to notice the change in the control.

In rates of change in the weighting values We, WΔθ, and WΔδf (which may be referred to as a fade gradient) at the time of giving the fade effect, each rate of change may be constant, or each rate of change may be changed.

Note that, in a case where the combination of the weighting values We, WΔθ, and WΔδf of the function group (1) is changed to the combination of the weighting values We, WΔθ, and WΔδf of the function group (2) (corresponding to the joint region J2), the fade effect may not be given. By rapidly changing the combination of the weighting values to the combination for emergency avoidance, it becomes possible to quickly transition to the steering angle control that performs steering at all costs to avoid danger.

Conversely, in a case where the combination of the weighting values We, WΔθ, and WΔδf of the function group (2) is changed to the combination of the weighting values We, WΔθ, and WΔδf of the function group (1) (corresponding to the joint region J2), the fade effect may be given. By gently changing the combination of the weighting values, it becomes possible to make it difficult for the occupant to notice that the steering angle control has suddenly changed.

### <Description of Flowchart>

FIG. 6A is a flowchart illustrating an example of computation processing executed by the processing unit 11 of the controller 10 in FIG. 2 according to a predetermined program. The processing illustrated in the flowchart is repeatedly executed, for example, while the subject vehicle 101 is traveling in the self-drive mode. In addition, the processing is repeatedly executed when the subject vehicle 101 is traveling in the manual drive mode and, for example, the lane keeping capability, which is one of the driving assistance capabilities, is enabled, that is, when the subject vehicle 101 is traveling in the lane keep driving.

In step S10, the controller 10 causes the steering angle control unit 161 to acquire the route information as the above-described target route, and proceeds to step S20.

In step S20, the controller 10 causes the steering angle control unit 161 to acquire the above-described vehicle state quantity and the like, and proceeds to step S30.

In step S30, the controller 10 causes the steering angle control unit 161 to perform the above-described model predictive control computation, and proceeds to step S40.

In step S40, the controller 10 causes the steering angle control unit 161 to perform the above-described target steering angle calculation, output a steering angle instruction value, and execute the steering angle control, and proceeds to step S50. Accordingly, the steering actuator AC1 is controlled based on the steering angle instruction value.

In step S50, the controller 10 determines whether or not to end the processing. For example, when the self-drive mode is released, the controller 10 makes an affirmative determination in step S50 and ends the processing according to FIG. 6A. For example, when the self-drive mode is continued, the controller 10 makes a negative determination in step S50, returns to step S10, and repeats the above-described processing.

FIG. 6B is a flowchart illustrating an example of processing of determining a weighting value. The processing illustrated in FIG. 6B is included in the processing of step S30 of FIG. 6A and is executed as a part of the processing by the prediction unit 161B1 and the optimization unit 161B2.

In step S300, the steering angle control unit 161 determines whether or not it corresponds to the above-described function group (3). When the above-described travel scene corresponds to “urban area”, the steering angle control unit 161 makes an affirmative determination in step S300 and proceeds to step S310. When the travel scene does not correspond to “urban area”, the steering angle control unit 161 makes a negative determination in step S300 and proceeds to step S320. A travel scene when a negative determination is made in step S300 corresponds to “expressway/main local road”.

In step S310, the steering angle control unit 161 uses, as the weighting value of the function group (3), the weighting value to be applied to the evaluation function of above Expression (9), and ends the processing according to FIG. 6B. More specifically, the steering angle control unit 161 applies, to the evaluation function of above Expression (9), the combination of the weighting values We, WΔθ, and WΔδf of the function group (3) determined in advance.

In step S320 to which the process proceeds when a negative determination is made in step S300, the steering angle control unit 161 determines whether or not the above-described traveling state corresponds to “emergency avoidance”. When determining that the above-described emergency avoidance flag is present, the steering angle control unit 161 makes an affirmative determination in step S320 and proceeds to step S330. When determining that there is no emergency avoidance flag, the steering angle control unit 161 makes a negative determination in step S320 and proceeds to step S340. A traveling state when a negative determination is made in step S320 corresponds to “normal traveling”.

In step S330, the steering angle control unit 161 sets, as the weighting value of the function group (2), the weighting value to be applied to the evaluation function of above Expression (9), and ends the processing according to FIG. 6B. More specifically, the steering angle control unit 161 applies, to the evaluation function of above Expression (9), the combination of the weighting values We, WΔθ, and WΔδf of the predetermined function group (2) determined in advance.

In step S340 to which the process proceeds when a negative determination is made in step S320, the steering angle control unit 161 sets, as the weighting value of the function group (1), the weighting value to be applied to the evaluation function of above Expression (9), and ends the processing according to FIG. 6B. More specifically, the steering angle control unit 161 applies, to the evaluation function of above Expression (9), the combination of the weighting values We, WΔθ, and WΔδf of the predetermined function group (1) determined in advance.

According to the embodiments described above, the following effects are obtained.

(1) A steering angle control apparatus 50 that controls a steering angle δf of a subject vehicle 101 so as to travel following a target route Tr includes: a prediction unit 161B1 that predicts, up to a predetermined time ahead, a behavior of the subject vehicle 101 including a deviation (e, Δθ) in a position and a direction of the subject vehicle 101 with respect to the target route Tr, based on a vehicle state quantity indicating a motion state of the subject vehicle 101 and information indicating the target route Tr; and an optimization unit 161B2 that optimizes a target steering angle by using a prediction result obtained by the prediction unit 161B1, in which the optimization unit 161B2 performs optimization using an evaluation function (equation (5)) including a first element intended to suppress the deviation (e, Δθ) and a second element intended to suppress a change amount of the steering angle δf.

With this configuration, it becomes possible to achieve both the action and effect obtained by including the first element in the evaluation function (to suppress the deviation from the target route Tr by performing steering) and the action and effect obtained by including the second element in the evaluation function (to suppress the influence caused by performing steering (for example, the ride comfort deteriorates due to the so-called lateral G)), and to appropriately correct the steering when the position of the subject vehicle 101 during traveling deviates from the target route Tr.

Note that the vehicle state quantity includes not only the first vehicle state quantities such as the vehicle speed V, the front-wheel steering angle δf, the front-wheel steering angle speed 6f, and the yaw angle speed γ acquired by the internal sensor group 2 of the subject vehicle 101, but also the second vehicle state quantities such as the steering angle disturbance δd and the slip angle R not acquired by the internal sensor group 2 of the subject vehicle 101 and estimated by the vehicle state estimation unit 161A.

(2) In the steering angle control apparatus 50 of above (1), the optimization unit 161B2 includes, as the first element, a route lateral position deviation e indicating a deviation between the target route Tr and the position of the subject vehicle 101 and a route heading angle deviation Δθ indicating a deviation from the target route Tr in an advancing direction of the subject vehicle 101 in the evaluation function (equation (9)), and includes, as the second element, the steering angle difference Δθf=(δf(k)−δf(k−1)) for each computation cycle in the evaluation function (equation (9)).

With this configuration, it becomes possible to suppress the route lateral position deviation e and the route heading angle deviation Δθ as the deviations from the target route Tr and to suppress the influence caused by performing steering.

(3) In the steering angle control apparatus 50 of above (1), the optimization unit 161B2 includes, as the first element, a route lateral position deviation e indicating a deviation between the target route Tr and the position of the subject vehicle 101 and a route heading angle deviation Δθ indicating a deviation from the target route Tr in an advancing direction of the subject vehicle 101 in the evaluation function, and includes, as the second element, the steering angle speed δf=(δf(k)−δf(k−1))/ts for each computation cycle in the evaluation function.

With this configuration, it becomes possible to suppress the route lateral position deviation e and the route heading angle deviation Δθ as the deviations from the target route Tr and to suppress the influence caused by performing steering.

(4) In the steering angle control apparatus 50 of above (1), the optimization unit 161B2 performs optimization using an evaluation function (Expression (9)) in which the combination of the weighting values We, WΔθ, and WΔδf for the first element and the second element is changed in accordance with the travel scene and the traveling state on the target route Tr.

With this configuration, for example, depending on whether the traveling state of the subject vehicle 101 is normal traveling or emergency avoidance, it becomes possible to prioritize control that suppresses a corrective steering angle regardless of centering the vehicle in a lane or to prioritize following the target route Tr by performing steering at all costs.

(5) In the steering angle control apparatus 50 of above (4), the optimization unit 161B2 performs optimization using an evaluation function (Expression (9)) in which a combination of weighting values We, WΔθ, and WΔδf for the first element and the second element is changed for each of normal traveling on a general road including at least an expressway (“expressway/main local road” normal traveling), emergency avoidance traveling on a general road (“expressway/main local road” emergency avoidance), and urban area traveling including an intersection of a general road (“urban area”), as a travel scene and a traveling state.

With this configuration, for example, it becomes possible to perform appropriate steering angle control for each travel scene in which the subject vehicle 101 travels. For example, in the “urban area”, the weighting values WΔθ and WΔδf are changed to be smaller than those in the scene of “expressway/main local road” normal traveling, so that the centering performance is prioritized as compared with the “expressway/main local road” normal traveling. As a result, for example, in a scene where the vehicle overtakes a parked vehicle on a road shoulder, the vehicle can travel with a small route lateral position deviation e in accordance with the target route Tr for avoiding the parked vehicle, and overtaking can be performed without discomfort.

(6) In the steering angle control apparatus 50 of above (4), the optimization unit 161B2 changes the combination of the weighting values We, WΔθ, and WΔδf for the first element and the second element in accordance with the route lateral position deviation e indicating a deviation between the target route Tr and the position of the subject vehicle 101.

With such a configuration, it becomes possible to achieve both the centering performance in a travel scene where the deviation from the target route Tr is small and the convergence performance to the target route Tr in a travel scene where the deviation from the target route Tr is large.

(7) In the steering angle control apparatus 50 of above (4), the optimization unit 161B2 changes the combination of the weighting values We, WΔθ, and WΔδf for the first element and the second element over a longer time than the computation cycle.

With this configuration, it becomes possible to gently change the combination of the weighting values so as not to give discomfort to the occupant of the subject vehicle 101. As a result, it is possible to make it difficult for the occupant to notice the change of the control.

(8) In the steering angle control apparatus 50 of above (4) to (7), the optimization unit 161B2 further quickly changes the combination of the weighting values We, WΔθ, and WΔδf for the first element and the second element when changing the combination during emergency avoidance traveling.

With such a configuration, during the emergency avoidance, the control is quickly changed to the control that allows significant steering, and the steering operation can be performed faster than in a case where the control is gently changed.

In the steering angle control, one of control targets is to bring a route heading angle deviation Δθ, which is a deviation angle from the target route Tr in the advancing direction (speed vector) of the subject vehicle 101, close to 0. A relationship of Δθ=Δψ+β is established when the route heading angle deviation ΔW, which is the deviation angle of the vehicle body orientation with respect to the target route Tr, and the vehicle body slip angle β are used, so that conventionally, the control to bring Δθ close to 0 is performed by adopting the state equation of the vehicle model in which Δψ and β are included in the state variables.

On the other hand, in the embodiment, the route deviation model is expressed in a steady state, and β is not treated as a state variable. Accordingly, in order to treat Δθ′=Δψ′, the element corresponding to the vehicle model in the conventional state equation has been designed to be incorporated into (coefficient matrix Bc) in the state equation (3) of the route deviation system according to the embodiment. As a result, even if the vehicle model in which Δψ and β are included in the state variables is not provided, the control to bring Δθ close to 0 can be performed.

Since there is no vehicle model including Δψ and β as state variables, the size of the coefficient matrix of above Expression (3) is extremely compact as compared with the conventional state equation. Accordingly, by reducing the number of the vehicle state quantities handled in the model predictive computation and reducing the computation load by the prediction unit 161B1, implementation on a lower-specification ECU and the like becomes possible.

In addition, by modeling the relationship in the steady state, continuity with control (for example, automatic parking control) in an extremely low speed range can be secured as compared with a case where the steady state is not set. Note that the prediction accuracy of the future behavior of the subject vehicle 101 is secured even when the route deviation model is expressed in the steady state, and thus, the performance of follow driving along the target path is not impaired.

The above embodiments may be modified into various modes. Hereinafter, modifications will be described.

### First Modification

The values of the weighting values We, WΔθ, and WΔδf for the first element and the second element determined for each travel scene illustrated in the above embodiments are merely examples. In addition, the values of the weighting values We, WΔθ, and WΔθf for emergency avoidance are merely examples. That is, the values of the weighting values We, WΔθ, and WΔδf applied to the evaluation function (Expression (5)) may be changed as appropriate.

### Second Modification

In the above embodiments, the vehicle speed (vehicle body speed) V [m/s] of the subject vehicle, the yaw angle speed (yaw rate) γ [rad/s], the front-wheel steering angle δf [rad], the gravitational acceleration g [m/s²], the steering angle speed δf [rad/s], the vehicle body orientation, the route lateral position deviation e [m], the route heading angle deviation Δψ [rad] of the vehicle body, the yaw angle speed deviation Δγ [rad/s], the steering angle disturbance δd, the vehicle body slip angle β [rad], and the like are exemplified as the vehicle state quantities, but, a state quantity other than the above may be added.

### Third Modification

The exemplified state equations and output equations are examples, and the state estimation model and the prediction model are not limited to those exemplified in the embodiments and may be changed as appropriate.

The above embodiment can be combined as desired with one or more of the aforesaid modifications. The modifications can also be combined with one another.

According to the present invention, it is possible to appropriately correct the steering when the position of the subject vehicle traveling along the target route deviates from the target route.

Above, while the present invention has been described with reference to the preferred embodiments thereof, it will be understood, by those skilled in the art, that various changes and modifications may be made thereto without departing from the scope of the appended claims.

What is claimed is:

1. A steering angle control apparatus configured to control a steering angle of a vehicle such that the vehicle travels following a target route, the steering angle control apparatus comprising:
a microprocessor; and
a memory connected to the microprocessor, wherein
the microprocessor is configured to perform:
predicting, up to a predetermined time ahead, a behavior of the vehicle including a deviation in a position and a direction of the vehicle with respect to the target route, based on a vehicle state quantity indicating a motion state of the vehicle and information indicating the target route; and
optimizing a target steering angle by using a result of the predicting, wherein
the microprocessor is configured to perform
the optimizing including performing optimization using an evaluation function including a first element intended to suppress the deviation and a second element intended to suppress a change amount of the steering angle.

2. The steering angle control apparatus according to claim 1, wherein
as the first element, a lateral position deviation indicating the deviation between the target route and the position of the vehicle and a heading angle deviation indicating a deviation from the target route in an advancing direction of the vehicle are included in the evaluation function, and as the second element, a steering angle difference for each computation cycle in the predicting is included in the evaluation function.

3. The steering angle control apparatus according to claim 1, wherein
as the first element, a lateral position deviation indicating the deviation between the target route and the position of the vehicle and a heading angle deviation indicating the deviation from the target route in an advancing direction of the vehicle are included in the evaluation function, and as the second element, a steering angle speed for each computation cycle in the predicting is included in the evaluation function.

4. The steering angle control apparatus according to claim 1, wherein
the microprocessor is configured to perform
the optimizing including performing the optimization using the evaluation function in which a combination of weighting values for the first element and the second element is changed in accordance with a travel scene and a traveling state on the target route.

5. The steering angle control apparatus according to claim 4, wherein
the microprocessor is configured to perform
the optimizing including performing the optimization using the evaluation function in which the combination of the weighting values for the first element and the second element is changed for each of normal traveling on a general road including at least an expressway, emergency avoidance traveling on the general road, and urban area traveling including an intersection of the general road, as the travel scene and the traveling state.

6. The steering angle control apparatus according to claim 4, wherein
the microprocessor is configured to perform
the optimizing including changing the combination of the weighting values for the first element and the second element in accordance with a lateral position deviation indicating a deviation between the target route and the position of the vehicle.

7. The steering angle control apparatus according to claim 4, wherein
the microprocessor is configured to perform
the optimizing including changing the combination of the weighting values for the first element and the second element over a longer time than the computation cycle.

8. The steering angle control apparatus according to claim 4, wherein
the microprocessor is configured to perform
the optimizing including quickly changing the combination of the weighting values for the first element and the second element when changing the combination during emergency avoidance traveling.

9. A steering angle control method for controlling a steering angle of a vehicle such that the vehicle travels following a target route, the steering angle control method comprising:
predicting, up to a predetermined time ahead, a behavior of the vehicle including a deviation in a position and a direction of the vehicle with respect to the target route, based on a vehicle state quantity indicating a motion state of the vehicle and information indicating the target route; and
optimizing a target steering angle by using a result of the predicting, wherein
the optimizing includes performing optimization using an evaluation function including a first element intended to suppress the deviation and a second element intended to suppress a change amount of the steering angle.
